(19) United States
(12) Patent Application Publication
(10) Pub. No.: US 2009/0226059 A1
(43) Pub. Date: Sep. 10, 2009

(54) Tissue Processing And Assessment

(76) Inventors: RICHARD LEVENSON, Brighton, MA (US); CLIFFORD C. HOYT, Wellesley, MA (US)

Correspondence Address: FISH & RICHARDSON PC, P.O. BOX 1022, MINNEAPOLIS, MN, 55440-1022, US

(21) Appl. No.: 12/369,684

(22) Filed: Feb. 11, 2009

Related U.S. Application Data
(60) Provisional application No. 61/027,993, filed on Feb. 12, 2008.

(51) Int. Cl. G06K 9/00; G01N 1/30

(52) U.S. Cl. 382/128; 435/40.52

(57) ABSTRACT

Disclosed are methods and systems that include: (a) fixing a tissue sample in a bath of fixing solution by directing ultrasonic waves to be incident on the tissue sample; (b) sectioning the tissue sample to produce a tissue section; (c) applying one or more stains to the tissue section; and (d) obtaining one or more images of the stained tissue section.

### CROSS-REFERENCE TO RELATED APPLICATIONS

This application claims priority under 35 U.S.C. §119(e) to U.S. Provisional Patent Application No. 61/027,993 entitled “TISSUE PROCESSING AND ASSESSMENT,” filed Feb. 12, 2008, the contents of which are incorporated herein by reference.

### TECHNICAL FIELD

This disclosure relates to manipulation of tissue samples, and in particular, to rapid processing and assessment of tissue sections.

### BACKGROUND

Anatomical and surgical pathology relies heavily on visual assessment of stained clinical tissue sections. Commonly used stains such as hematoxylin and eosin (H&E) achieve specificity based upon how the stains interact with molecules and components of tissue sections. Tissue stains reveal disease-specific tissue morphologies, which can provide visual cues for diagnosis of disease states. Personalized medicine—which promises to provide more accurate diagnoses, better targeted therapies, and response monitoring—relies on determining a particular patient's disease configuration by employing a molecular probe which can be, for example, a stain applied to a tissue section. Once a tissue section has been stained, the sample is assessed visually by a trained surgical pathologist. Based on the pathologist's assessment, a determination of the patient's particular disease configuration can be made.

### SUMMARY

In general, in a first aspect, the disclosure features a method that includes: (a) fixing a tissue sample in a bath of fixing solution by directing ultrasonic waves to be incident on the tissue sample; (b) sectioning the tissue sample to produce a tissue section; (c) applying one or more stains to the tissue section; and (d) obtaining one or more images of the stained tissue section.

Embodiments of the method can include one or more of the following features.

The tissue sample can be obtained for a patient and the method can further include analyzing the one or more images to provide information useful for assessing a disease state in the patient. Furthermore, the method can further include assessing the disease state in the patient based on the information.

The method can further include displaying one or more of the obtained images.

The tissue sample can be obtained by excising the tissue sample from the patient during an operation. Alternatively, or in addition, the tissue sample can be obtained from a sample storage facility.

The tissue sample can be fixed over an elapsed time of 5 minutes or less. The fixing solution can include formaldehyde. Alternatively, the fixing solution can include zinc-based compounds. For example, the fixing solution can include zinc chloride and/or calcium acetate and/or zinc trifluoroacetate.

Prior to sectioning the tissue sample, the sample can be enveloped in a solid material. For example, the solid material can include agarose. In certain embodiments, the solid material does not include paraffin. Furthermore, in certain embodiments, the sample is not dehydrated prior to enveloping the sample. Moreover, in certain embodiments, the solid material does not permeate the sample.

The sectioning can include removing a portion of the tissue sample with an oscillating blade.

The method can include directing ultrasonic waves to be incident on the tissue sample when the one or more stains are applied.

The one or more stains can include materials that include quantum dots. Alternatively, or in addition, the one or more stains can include a hapten compound.

Analyzing the one or more images can include spectrally unmixing the one or more images to separate the one or more images into a plurality of component images, each component image corresponding to an individual spectral contribution to the one or more images. At least some of the individual spectral contributions can correspond to the one or more stains applied to the tissue section. At least one of the individual spectral contributions can correspond to tissue autofluorescence.

Analyzing the one or more images can include classifying one or more regions of the images. Classifying one or more regions can include assigning each of the one or more regions to a particular class based on tissue morphology in each of the one or more regions. The classification can be based on an image of the tissue section that includes spectral contributions substantially only from a counterstain applied to the tissue section. The classification can be performed by a neural network-based trained classifier.

Analyzing the one or more images can include classifying cells within one or more of the classified regions. The method can include identifying at least some of the nuclei of the classified cells.

Assessing a disease state in the patient can include determining the presence or absence of a disease in the patient. For example, the disease can be cancer.

Assessing a disease state in the patient can include determining counts of cells in the tissue section that are stained with at least one of the one or more stains.

Assessing a disease state in the patient can include determining counts of cells in the tissue section that are stained with more than one of the one or more stains.

Assessing a disease state in the patient can include providing a signal to a surgeon, where the signal indicates to the surgeon to continue a surgical operation or to halt a surgical operation.

The method can be performed during a surgical operation.

An elapsed time between a beginning of the fixing and an end of the analyzing can be three hours or less (e.g., two hours or less, one hour or less, 30 minutes or less, 20 minutes or less).

Embodiments of the method can also include any of the other method steps disclosed herein, as appropriate.

In another aspect, the disclosure features a system that includes: (a) a fixing sub-system configured to fix a tissue sample obtained from a patient in a bath of fixing solution; (b) a sectioning sub-system configured to produce a tissue section from the tissue sample; (c) a labeling sub-system configured to apply one or more stains to the tissue section; (d) an imaging sub-system configured to obtain one or more images of the stained tissue section; and (e) a processor configured to analyze the one or more images and provide information useful for assessing a disease state in the patient.

Embodiments of the system can include one or more of the following features.

The processor can be configured to assess a disease state in the patient based on the information.

The fixing sub-system can include a transducer configured to generate ultrasonic waves during the fixing.

The sectioning sub-system can include a reciprocating cutting tool configured to remove a portion of the sample to produce the tissue section.

The system can include a display configured to receive images of the tissue section, and to display the images. The display can be configured to overlay images of the tissue section that correspond to different spectral components to form a composite image.

Embodiments of the system can also include any other features disclosed herein, as appropriate.

In a further aspect, the disclosure features a method that includes fixing a tissue sample obtained from a patient in a bath of fixing solution, sectioning the fixed tissue sample to produce a tissue section, applying one or more stains to the tissue section, obtaining one or more images of the stained tissue section, and analyzing the one or more images to provide information useful for assessing a disease state in the patient, where an elapsed time from a beginning of the fixing to an end of the analyzing is less than 60 minutes.

Embodiments of the method can include one or more of the following features.

The method can include assessing a disease state in the patient based on the information.

The elapsed time can be 30 minutes or less (e.g., 20 minutes or less).

The method can be performed during a surgical operation. The method can include assessing a disease state in the patient based on the information, where the assessing includes providing a signal to a surgeon to continue the operation or halt the operation.

Unless otherwise defined, all technical and scientific terms used herein have the same meaning as commonly understood by one of ordinary skill in the art to which this disclosure belongs. Although methods and materials similar or equivalent to those described herein can be used in the practice or testing of the present disclosure, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the disclosure are set forth in the accompanying drawings and the description below. Other features and advantages will be apparent from the description, drawings, and claims.

### DESCRIPTION OF DRAWINGS

FIG. 1 is schematic diagram of an automated tissue assessment system.

FIG. 2 is a flow chart showing steps in an automated tissue handling protocol.

FIG. 3 is a schematic diagram of an embodiment of an ultrasonic fixation chamber.

FIGS. 4A-4C are schematic diagrams that show different stages of tissue sectioning.

Like reference symbols in the various drawings indicate like elements.

### DETAILED DESCRIPTION

The excision, preparation, and visual assessment of a tissue section by a surgical pathologist is typically a relatively slow procedure that can take from one to several days. Further, pathologist assessments—which are performed by eye—are typically not accurate enough to extract quantitative data regarding cellular phenotypes and sub-cellular structure. As a result, standard methods of assessment of tissue sections are typically limited to relatively slow turnaround times between tissue excision and diagnosis. Moreover, the diagnoses provided, if based exclusively on non-quantitative assessment of tissue sections, often do not reveal enough detail to make definitive conclusions about, for example, the rate of advance of particular disease conditions.

Disclosed herein are systems and methods for rapid, automated assessment of tissue sections. The methods and systems are capable of providing information useful for making diagnoses and/or treatment determinations in relatively short amounts of time, with turnaround times as short as 20 minutes between tissue excision and completed assessment. As a result, the systems and methods can permit same-day diagnoses and, in some cases, can permit intra-operative assessment during biopsies (e.g., enabling assessment of a biopsy section before the biopsy is completed). This enables clinical decisions regarding treatment to be made during surgery. Furthermore, because the assessment is largely or completely automated, the intervention of a pathologist—either in the operating room or in a laboratory—is typically not required.

The systems and methods disclosed herein also enable multiplexed assessment based on two or more immunohistochemical (IHC) and/or immunofluorescent (IF) stains by employing spectral unmixing techniques to separate different contributions from the different stains to images of stained tissues. Multiplexed assessments offer multiple advantages, including potential diagnosis of conditions which might be missed in singly-stained tissue sections, and more rapid assessments because the need for a plurality of tissue sections, each stained with a different IHC or IF stain, is eliminated. In addition, the rapid fixation and sectioning of excised tissue improves the molecular sensitivity of the applied stains compared to conventional fixation and staining protocols, thereby enabling improved assessments.

### General Overview

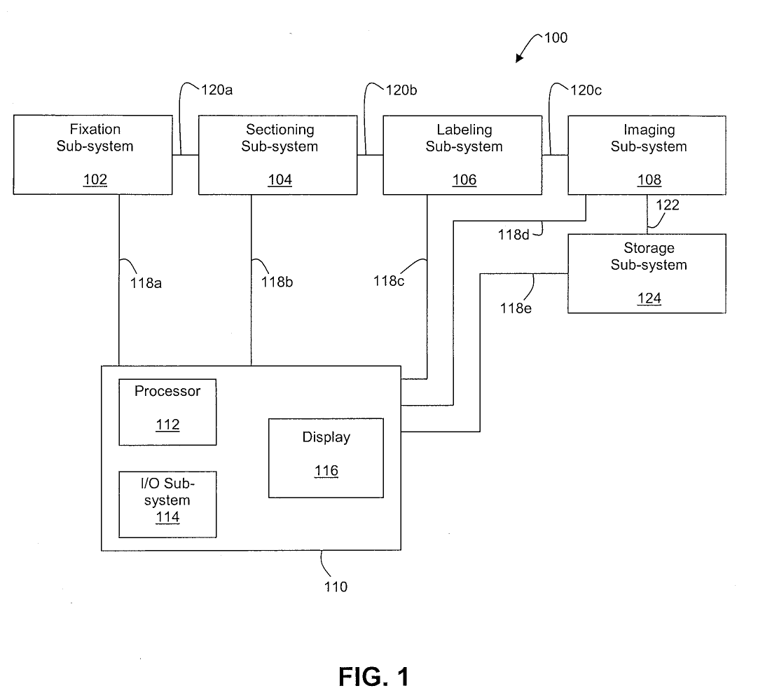

A schematic diagram of an automated tissue assessment system 100 is shown in FIG. 1. Tissue assessment system 100 features a series of sub-systems including a sample fixation sub-system 102, a sample sectioning sub-system 104, a sample labeling sub-system 106, and a sample imaging sub-system 108. Fixation sub-system 102, sectioning sub-system 104, labeling sub-system 106, and imaging sub-system 108 are connected by sample transport systems 102a, 120b, and 120c which carry samples (or portions thereof) between the automated sub-systems of assessment system 100. Assessment system 100 also includes an optional transport system 122 that can transport samples to a storage sub-system 124 following imaging and assessment.

The various sub-systems of assessment system 100 are controlled by electronic control system 110, which includes a processor 112, an input/output sub-system 114, and a display 116. Electronic control system 110 is connected to the various sub-systems of assessment system 100 by communication lines 118a-e.

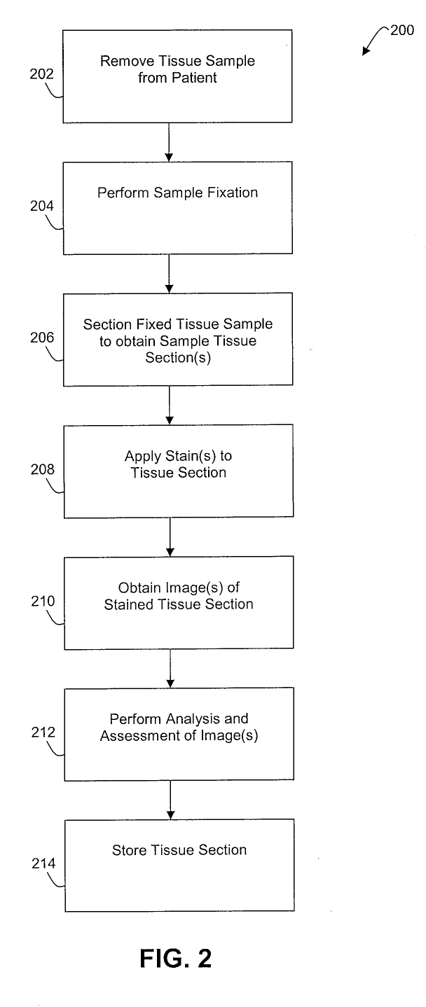

Tissue assessment system 100 is generally configured to perform an automated tissue handling protocol that permits processing, staining, imaging, assessment, and storage of sections taken from the sample. FIG. 2 is a flow chart 200 that shows various steps in the tissue handling protocol performed by assessment system 100. The steps are typically performed by the various sub-systems of assessment system 100.

The first step 202 in flow chart 200 includes removing a candidate tissue sample from a patient. Typically, the sample is removed during a biopsy operation where assessment of the removed sample for diagnostic and therapeutic purposes is desired. However, in some embodiments, the tissue sample can be retrieved from storage, having been previously excised from the patient. The sample is introduced into fixation sub-system 102 of assessment system 100 to initiate sample assessment.

### Sample Fixation

Once inside fixation sub-system 102, the sample undergoes a fixation procedure in step 204 of flow chart 200. As is well-understand in the art, such “fixing” of the tissue sample means treating the sample to reduce subsequent tissue decay and necrosis. Standard fixation typically involves methods such as placing tissue in a bath of neutral-buffered formalin solution (e.g., 10% formaldehyde) for a period of 16-24 hours. However, the methods disclosed herein provide for much more rapid fixation of the tissue—within a period of 5-15 minutes—so that fixed tissues are available for rapid assessment. To achieve rapid fixation, fixation sub-system 102 includes a fixation chamber that applies ultrasonic waves to the tissue sample in a bath of fixation solution. Suitable fixation chambers and methods are disclosed, for example, in the following publications: Wei-Sing Chu et al., “Ultrasound-accelerated formalin fixation of tissue improves morphology, antigen and mRNA preservation,” Modern Pathology 18: 850-863 (2005); and Wei-Sing Chu et al., “Ultrasound-accelerated Tissue Fixation/Processing Achieves Superior Morphology and Macromolecule Integrity with Storage Stability,” Journal of Histochemistry & Cytochemistry 54(5): 503-513 (2006). The contents of each of the foregoing publications are incorporated herein by reference in their entirety.

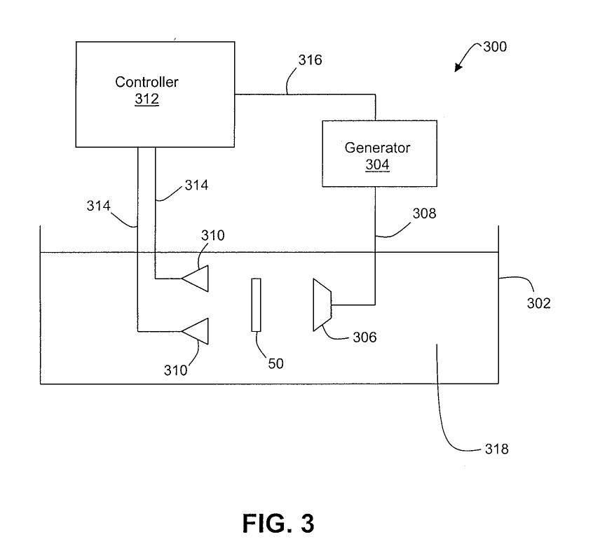

FIG. 3 shows a schematic diagram of an ultrasonic fixation chamber 300. Fixation chamber 300 includes a reservoir 302 that holds fixation solution 318, in which a tissue sample 50 is suspended. An ultrasonic transducer 306 is positioned on one side of sample 50. Transducer 306 is connected to signal generator 304 via communication line 308. On the other side of sample 50, one or more ultrasonic sensors 310 are optionally positioned to detect ultrasonic waves generated by transducer 306. The ultrasonic sensors 310 are connected to controller 312 via communication lines 314. Controller 312 is also connected to generator 304 via communication line 316, and to processor 112 in electronic control system 110.

To perform the fixation procedure once sample 50 is positioned in reservoir 302, electronic control system 110 directs controller 312 to initiate ultrasonic fixation. Controller 312 sends a control sequence to generator 304, causing generator 304 to generate an electrical waveform having a particular shape, amplitude, and duration. The generated electrical waveform is communicated to transducer 306, which causes transducer 306 to generate ultrasonic waves in fixation solution 318. The ultrasonic waves cause rapid fixation of sample 50 in fixation solution 318. If present, ultrasonic sensors 310 detect ultrasonic waves generated by transducer 306 and which are transmitted through sample 50. Sensors 310 report to controller 312 measured intensities and/or amplitudes of the transmitted ultrasonic waves.

In some embodiments, the length of the fixation procedure can be determined in advance (e.g., as a control setting in electronic control system 110), and controller 312 can be configured to limit the duration of the ultrasonic waveform produced by transducer 306 based on the pre-determined length of the fixation procedure. For example, in certain embodiments, the duration of the ultrasonic waveform can be 30 minutes or less (e.g., 25 minutes or less, 20 minutes or less, 15 minutes or less) and/or 5 minutes or more (e.g., 7 minutes or more, 9 minutes or more, 11 minutes or more).

In some embodiments, controller 312 can be configured to determine a relative degree of fixation of sample 50 based on an intensity and/or an amplitude of the transmitted ultrasonic waves detected by sensors 314. For example, as fixation of sample 50 proceeds, sample 50 typically becomes less compliant, and the amplitude and intensity of the transmitted ultrasonic waves changes. Controller 312 can assess the degree of fixation of sample 50 based on the detected transmitted ultrasonic waves, and can allow the ultrasonic fixation procedure to continue until a particular ultrasonic wave amplitude and/or intensity—indicating a particular degree of fixation—is detected.

In some embodiments, the intensity of the ultrasonic waves applied to sample 50 by transducer 306 is 3 W/cm² or more (e.g., 5 W/cm² or more, 7 W/cm² or more, 10 W/cm² or more, 13 W/cm² or more). In certain embodiments, the intensity of the ultrasonic waves is 25 W/cm² or less (e.g., 23 W/cm² or less, 21 W/cm² or less, 19 W/cm² or less, 16 W/cm or less).

In some embodiments, the frequency of the ultrasonic waves applied to sample 50 by transducer 306 is 1.50 MHz or more.

Without wishing to be bound by theory, it is believed that microcavitation caused by the ultrasonic waves generated by transducer 306 increases the rate at which fixation solution 318 permeates sample 50, thereby permitting a more rapid rate of fixation than would otherwise be possible in the absence of the ultrasonic waves. Further, the application of relatively high frequency ultrasonic waves avoids tissue destruction which can occur in samples subjected to lower frequency ultrasonic waves (e.g., ultrasonic waves in a frequency range of from about 25 kHz to about 75 kHz).

In some embodiments, fixation solution 318 can include a 10% neutral-buffered formalin solution, such as is typically used in standard tissue fixation. In certain embodiments, fixation solutions that include zinc-based compounds can be used. Exemplary zinc-based fixative solutions include: an aqueous solution of 0.5% zinc chloride, 0.5% zinc acetate, and 0.05% calcium acetate in 0.1 M Tris-HCl; an aqueous solution of 0.5% zinc chloride, 0.05% calcium acetate in 0.1 M Tris-HCl, and 17.16 mM zinc trifluoroacetate; an aqueous solution of 0.5% zinc chloride, 0.05% calcium acetate in 0.1 M Tris-HCl, and 17.16 mM zinc trifluoroacetate+5% (v/v) DMSO (dimethyl sulfoxide); an aqueous solution of 0.5% zinc chloride, 0.05% calcium acetate in 0.1 M Tris-HCl, and 8.10 mM zinc citrate; an aqueous solution of 0.5% zinc chloride, 0.05% calcium acetate in 0.1 M Tris-HCl, and 20.05 mM zinc tartrate; an aqueous solution of 0.5% zinc chloride, 0.05% calcium acetate in 0.1 M Tris-HCl, and 20.05 mM zinc tartrate+5% DMSO; an aqueous solution of 0.5% zinc chloride, 0.05% calcium acetate in 0.1 M Tris-HCl, and 18.69 mM zinc isovalerate.

In general, other zinc-based fixation solutions are also possible by adjusting the relative concentrations of the various constituents of the solutions disclosed above. Other solution constituents are also possible. For example, any of the zinc-based compounds in the solutions disclosed above can be replaced by their manganese, magnesium, gallium, and vanadium analogs. Further, diethyl pyrocarbonate (DEPC) and/or ethylenediaminetetraacetic acid (EDTA) can be included in addition to, or in place of, DMSO in any of the fixation solutions disclosed above.

In particular, it has been found that a fixation solution that includes an aqueous solution of 0.5% zinc chloride, 0.05% calcium acetate in 0.1 M Tris-HCl, and 17.16 mM zinc trifluoroacetate is particular effective as a fixative for tissue samples, demonstrating good antigen preservation and preservation of DNA and RNA integrity.

### Sample Sectioning

The next step 206 in flow chart 200 is to perform sectioning of the fixed tissue sample to obtain a thin tissue section for assessment. In standard tissue preparation protocols, fixed samples are dehydrated using agents such as alcohols (e.g., ethanol, methanol) and embedded in paraffin, which provides a structural supporting material for the tissue sample. The paraffin-embedded sample is then sliced into thin sections which are used for assessment purposes. However, paraffin-embedding of tissue samples is typically a time-consuming process. The time required for paraffin-embedding and subsequent microtome sectioning can be long enough that levels of labile antigens and/or post-translational modifications may no longer accurately reflect concentrations present in vivo.

Further, paraffin-embedding can destroy or render certain antigens undetectable, even when antigen retrieval methods are used. In particular, dehydrating fixed tissue samples creates pores in the samples that were previously occupied by water. When paraffin is introduced, the paraffin permeates the sample, filling the vacant pores. Paraffin permeation can significantly alter the local tissue environment and molecular constituents therein, obscuring and therefore preventing detection of certain constituents.

As a result, in step 206, rapid, non-destructive sectioning of the fixed tissue sample is performed to enable accurate, timely delivery of tissue sections for staining and assessment. Step 206 is performed in sectioning sub-system 104 of assessment system 100, which receives the fixed tissue sample from fixation sub-system 102 via transport system 120a. The methods and systems disclosed herein avoid the dehydration and paraffin-embedding steps that are typically used in tissue processing protocols. Instead, tissue samples are enveloped in a low melting temperature solid without dehydration. As a result, the solid—which functions as a support material for the tissue during sectioning—supports the tissue but does not permeate the tissue in the manner that paraffin typically does, because water-free pores are not created in the tissue sample. The enveloped tissue sample can then be sectioned to create thin tissue sections for staining and assessment.

Because the dehydration and paraffin-embedding steps are omitted, paraffin permeation—which proceeds relatively slowly—does not occur, reducing tissue processing time. Preparation of tissue samples for sectioning is therefore typically significantly faster than in standard tissue processing protocols.

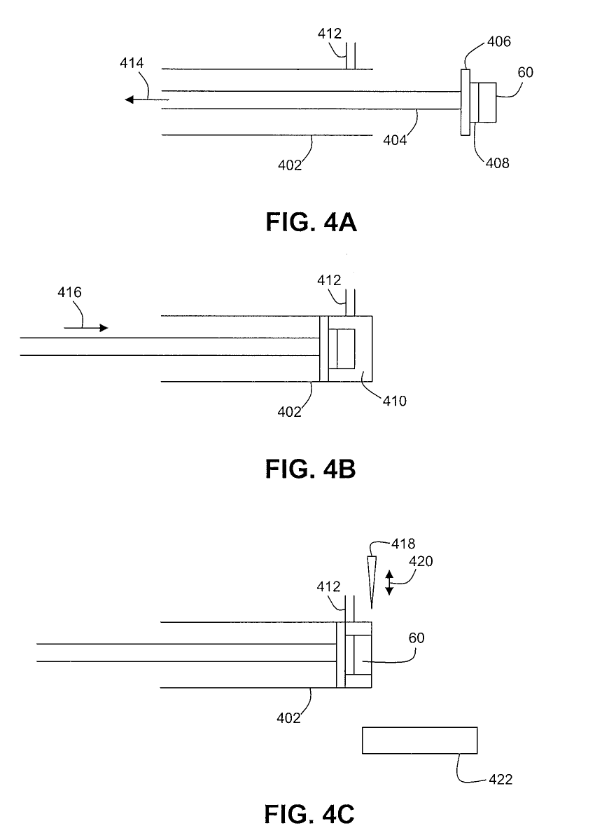

Sectioning sub-system 104 includes a sectioning device that includes a mount for the tissue sample, a vessel in which the tissue sample can be enveloped with a low melting point solid, and a reciprocating cutting tool (e.g., an oscillating blade) that performs rapid sectioning of the fixed, enveloped tissue sample. FIGS. 4A-C are schematic diagrams that show different stages of tissue sample preparation and sectioning using the reciprocating cutting tool. In FIG. 4A, a plunger that includes a plunger head 406 and a plunger shaft 404 can move axially within a support tube 402. A drop of adhesive (e.g., tissue glue) is used to affix fixed sample 60, which is typically about 0.5 cm thick, to plunger head 406. Plunger head 406 is then withdrawn into support tube 402 by translating plunger head in the direction shown by arrow 414.

Once plunger head 406 and sample 60 are within tube 402, a low melting point solid 410 is introduced (in liquid form) into tube 402 through tube 412 to envelope sample 60 and fill any voids in tube 402, as shown in FIG. 4B. An exemplary low melting point solid suitable for enveloping sample 60 is agarose. Once the liquid has solidified, the solid acts as a support material for fixed tissue sample 60. A motor (not shown) then automatically advances the plug in tube 402, consisting of sample 60 and the low-melting solid, in the direction indicated by arrow 416.

A reciprocating cutting tool 418, which oscillates in the direction indicated by arrow 420 in FIG. 4C, slices off portions of the plug, some of which include thin sections of the fixed tissue sample 60. The sections fall into water bath 422, and each sample is thereafter automatically transported to a fresh, positively charged slide. The tissue sections can optionally be dried briefly, causing the sections to adhere to the slides. Exemplary reciprocating cutting tool systems suitable for sectioning sample 60 include slicing systems, available from Precisionary Instruments (Greenville, N.C.).

All of the steps described above are performed automatically in sectioning sub-system 104. Automatic sectioning using the reciprocating cutting tool typically yields tissue sections with a thickness of between 5 μm and 20 μm (e.g., between 5 μm and 15 μm, between 5 μm and 10 μm, between 5 μm and 8 μm). The tissue sections are automatically mounted on slides, as discussed above, and then the mounted sections are directed via transport system 120b to labeling sub-system 106. Typically, the entire sectioning process takes place over a time window of 15 minutes or less (e.g., 13 minutes or less, 10 minutes or less, 8 minutes or less, 5 minutes or less).

A particular advantage of reciprocating cutting tool-based sectioning is that antigen retrieval tissue processing steps are obviated. In standard tissue sectioning protocols, microtome sectioning is typically followed by one or more antigen retrieval steps to enhance antigen detection and binding during subsequent staining. Reciprocating cutting tool-based sectioning, however, is particularly efficient at preserving antigens in tissue sections, including labile proteins which may be important in unambiguous identification of disease mechanisms in cancer cells, so that time-consuming antigen retrieval steps can be omitted.

In some embodiments, cryogenic sectioning can be used to produce thin tissue sections for subsequent assessment. In cryogenic sectioning, the sample is combined with a small amount of a freezing compound and cooled to a temperature well below the freezing point of water (e.g., to liquid nitrogen temperature or below). The freezing compound helps to support the frozen tissue sample structurally. Following freezing, the sample can be sectioned into thin wafers using a standard microtome. Suitable freezing compounds include, for example, Tissue-Tek® Optimal Cutting Temperature (OCT) Compound, available from Sakura Finetek USA (Torrance, Calif.).

### Tissue Section Labeling

The next step 208 in flow chart 200 involves the application of one or more IHC and/or IF stains to prepared tissue sections. Step 208 is typically performed in the labeling sub-system 106 of assessment system 100.

In step 208, disease-related proteins and other targets in cells within the tissue section are labeled with one or more stains and/or markers. Typically, for example, the cells are disease-related cells such as cancer cells, and the targets are antigens which may provide information regarding disease-state assessment and treatment. In certain embodiments, the staining protocol involves two steps: first, an application step in which a cocktail that includes one or more stains is applied to the tissue section; second, a washing step, in which excess stain is removed from the tissue section.

Various mixtures of stains can be used in staining protocols. In some embodiments, for example, one or more chromogenic IHC stains can be applied to a tissue section. In certain embodiments, one or more IF stains can be applied in addition to, or in the alternative to, the IHC stains.

In some embodiments, quantum dot-based markers can be applied to tissue sections. Typically, quantum dots emit bright fluorescence with emission spectra that are relatively narrow. However, by tuning quantum dot sizes, the central fluorescence emission wavelength of the dots can be varied. Thus, markers can be chosen which have fluorescence emission at any of a broad range of wavelengths from the near ultraviolet region to the near infrared region of the electromagnetic spectrum. The spectral narrowness of quantum dot fluorescence emission and the ability to excite dots which fluoresce at different wavelengths using the same excitation source make quantum dot markers useful for multiplexed staining protocols. Typically, for example, multiplexed protocols can include labeling tissue sections with two or more (e.g., three or more, four or more, five or more, six or more, eight or more, ten or more) different stains and/or markers.

A particular advantage of using quantum dot labels is that direct labeling of antibodies and other cellular targets with quantum dots avoids time consuming enzymatic amplification steps, which may have to be done sequentially in conventional multiplexed molecular staining protocols. Quantum dot-based labels can be applied all at once to tissue sections, reducing the time required to complete a staining protocol from hours or days to minutes.

In some embodiments, double antibody procedures can be used in multiplexed staining protocols. For example, conventional unlabeled primary and labeled secondary antibodies can be used. Alternatively, for example, hapten-based staining techniques can be used.

In certain embodiments, sonication during staining can decrease the time required to complete a staining protocol. For example, ultrasonic waves can be applied to a tissue section in a staining bath in the same manner described above in connection with tissue fixation. The ultrasonic waves can be generated via a transducer that receives an electrical waveform from a generator that is ultimately controlled by electronic control system 110. Labeling sub-system 106 can be equipped with a sonication chamber similar to the chamber shown in FIG. 2. The ultrasonic waves can be applied only during the application of stain to the tissue section, or during both the application and washing steps.

In some embodiments, a counterstain can also be applied to the tissue section. Typically, counterstains are non-specific stains that enhance visualization of cell morphology and structure. Images of features on counterstained tissue sections can be easier to identify due to the structural cues highlighted by the counterstain. Exemplary counterstains that can be applied during the staining protocol include hematoxylin.

In certain embodiments, labels specific to certain cellular features can be applied during the staining protocol. For example, nuclear labels such as DAPI can be applied. Images that include structure-specific labels can also provide enhanced visual cues that assist the identification of cells of interest.

A particular advantage of the methods and systems disclosed herein is that they permit staining of the same cells in a tissue section with multiple labels. Standard approaches to multiplexing include the serial section technique, in which tissue sections which are sequential slices from a paraffin-embedded sample are stained individually for different antigens. Typically, cells which appear in one section do not appear on other sections. As a result, each tissue section includes a different selection of cells from the excised sample, introducing a source of uncertainty into any comparative assessments based on the sample's response to different antigen-specific stains. However, the systems and methods disclosed herein permit interrogation of the same subset of cells, ensuring that variations in response to applied stains are not due to sampling errors.

Following staining, a coverslip can be applied to tissue sections for protection of the sections. The coverslip can be applied as a drop of transparent compound that hardens over the tissue sections, or as a more conventional thin glass or plastic sheet.

### Tissue Section Imaging

Stained tissue sections are conveyed from labeling sub-system 106 to imaging sub-system 108 via transport system 120c, and then in step 210 of flow chart 200, one or more spectral images of the stained tissue sections are obtained. Spectral images are typically obtained in automated fashion in a microscope system that includes one or more light sources for illuminating tissue sections, and one or more detectors for capturing images of the tissue sections. For example, imaging sub-system 108 can include one detector configured to capture wavelength-resolved fluorescence images of the tissue section, and another detector configured to capture wavelength-resolved transmitted light images (e.g., brightfield images) of the tissue section. Imaging sub-system 108 can include suitable optical elements for isolating optical signals that correspond to fluorescence images from optical signals that correspond to brightfield images. The optical elements can include, for example, optical bandpass filters and/or tunable liquid crystal filters for isolating particular spectral signals for detection.

Image capture is fully automated in imaging sub-system 108, including automated filter and lens selection, and automated tissue section alignment and translation. Typically, imaging proceeds by first performing a high-speed, low power (e.g., 4×) acquisition of an RGB image of the whole sample (which takes about 30 seconds), followed by performing an automated target recognition process on the captured image. Following identification of suitable target regions, a series of higher-power (e.g., 20×-40×) images are captured for quantitative analysis. This approach keeps overall acquisition and analysis time relatively short, while still permitting collection of accurate quantitative data. In some embodiments, for example, total acquisition time for both low power and high power images is 5 minutes or less (e.g., 4 minutes or less, 3 minutes or less, 2 minutes or less).

In certain embodiments, imaging sub-system 108 can be configured to obtain one or more birefringence images of the stained tissue sections. The one or more birefringence images can be obtained in addition to, or in the alternative to, spectral images of the tissue sections. Birefringence images can provide information regarding both a spatially-resolved magnitude and a direction of birefringence for the tissue sections. Suitable systems and methods for acquiring and analyzing birefringence images of samples are disclosed, for example, in the following patents and patent applications: U.S. patent application Ser. No. 11/397,336 entitled “BIOLOGICAL SAMPLE HANDLING AND IMAGING” by Clifford C. Hoyt et al., filed on Apr. 4, 2006; U.S. Pat. No. 5,521,705 entitled “POLARIZED LIGHT MICROSCOPY” by Rudolf Oldenbourg and Guang Mei, filed on May 12, 1994; and U.S. Pat. No. 6,924,893 entitled “ENHANCING POLARIZED LIGHT MICROSCOPY” by Rudolf Oldenbourg et al., filed on May 12, 2003. The entire contents of each of the foregoing publications are incorporated herein by reference.

### Image Analysis and Assessment

In step 212 of flow chart 200, the images obtained in step 210 are sent to electronic control system 110 for analysis. Typically, the first analysis step that is performed is a spectral unmixing step, even if a tissue section is stained with only one type of label. Systems and methods for spectral unmixing are generally disclosed, for example, in the following patent applications: U.S. patent application Ser. No. 10/669,101 entitled “SPECTRAL IMAGING OF DEEP TISSUE” by Richard Levenson et al., filed on Sep. 23, 2003, now published as U.S. Publication No. US 2005/0065440; PCT Patent Application No. PCT/US2004/031609 entitled “SPECTRAL IMAGING OF BIOLOGICAL SAMPLES” by Richard Levenson et al., filed on Sep. 23, 2004, now published as PCT Publication No. WO 2005/040769 and U.S. Publication No. US 2008/0294032; and U.S. patent application Ser. No. 10/573,242 entitled “SPECTRAL IMAGING OF BIOLOGICAL SAMPLES” by Richard Levenson et al., filed on Mar. 22, 2006, now published as U.S. Publication No. US 2007/0016082. The entire contents of each of the foregoing applications are incorporated herein by reference.

Spectral unmixing corresponds to a linear decomposition of an image or other data set into a series of contributions from different spectral contributors. Images of stained tissue sections typically include at least two different contributions: contributions from each of the individual stains applied to the tissue section; and an autofluorescence contribution that arises from background fluorescence of the tissue. The contributions from the individual stains can include one or more contributions from IHC labels (e.g., brightfield contributions) and/or IF labels (e.g., darkfield contributions). Contributions to the stained tissue images can also arise from counterstains such as hematoxylin. Each of these contributions can be unmixed or decomposed into a separate spectral channel, forming an image of the stained tissue section that corresponds almost entirely to signal contributions from single spectral sources. When the contributions are unmixed into separate channels or images, signal strengths can be accurately quantified and analyzed.

The numerical spectral unmixing procedure will be described below for a tissue section that is stained with a single IF label. The equations can be generalized in straightforward fashion to include spectral contributions from multiple stains. The spectral data recorded at a given point (x,y) in an image depends on the amount of fluorescence from the IF stain and on tissue autofluorescence as:

S(x,y,λ)=a(x,y)*F(λ)+b(x,y)*G(λ) [1]

where (x, y) indices are used to denote a given pixel location in the image, the asterisk “*” denotes multiplication, λ is used to denote a given wavelength of fluorescence emission or detection, and

S(x, y, λ) denotes the net signal for a given location and wavelength,

F(λ) denotes the emission spectrum of autofluorescence,

G(λ) denotes the emission spectrum of the IF stain,

a(x, y) indicates the abundance of autofluorescence signal at a given (x, y) location, and

b(x, y) indicates the abundance of IF stain fluorescence at a given (x, y) location.

Equation [1] states that the net signal from a given location is the sum of two contributions, weighted by the relative amount of autofluorescence and IF stain fluorescence present. It is easier to see if one writes the above equation for a single pixel:

S(λ)=aF(λ)+bG(λ) [2]

F and G may be termed the spectral eigenstates for the system, which are combined in various amounts according to the amount of autofluorescence and IF stain emission, to produce an observed spectrum S.

Now if the emission spectra of the autofluorescence and of the IF stain are known (or can be deduced), one may invert equation [2] by linear algebra to solve for a and b, provided that the spectrum S has at least two elements in it, i.e., that one has data for at least two emission wavelengths λ. Then we can write

A=E⁻¹S [3]

where

A is a column vector with components a and b, and

E is the matrix whose columns are the spectral eigenstates, namely [F G].

Using equation [3], one can take the captured spectral images and calculate the abundance of the autofluorescence and of the IF stain sources. This process can be repeated for each pixel in the image, to produce separate images of the tissue section that correspond substantially to autofluorescence only, and to IF stain fluorescence only, and are free of contributions from other spectral sources. Note that the matrix E need only be inverted once for a given set of autofluorescence and IF stain spectra, so the calculation of abundances is not burdensome and can be readily done in nearly real-time by a personal computer.

In some embodiments, when multiple stains are applied to a tissue section, the individual spectra (e.g., the spectral eigenstates discussed above) of the stains are different than the spectra of the stains applied individually to tissue sections. These changes can arise, for example, from chemical interactions between the various stains, and/or from environmental conditions during or after the staining protocol. As long as these changes can be quantitatively reproduced in control experiments to provide accurate spectral eigenstates for the unmixing algorithm, however, the individual contributions of these stains to spectral images of the tissue section can be deconvolved to obtain quantitative information about the absolute amount of each stain present in the tissue section.

Typically, when multiple stains are used in a staining protocol, the stains are selected so that they overlap as little as possible spectrally, which assists the unmixing algorithm in achieving an accurate decomposition. However, in some embodiments, stains can be employed which have overlapping spectral features. The unmixing algorithm can still accurately separate the contributions of the spectrally overlapped stains, provided the spectral eigenstates corresponding to the individual stains are known with relatively high accuracy.

Following spectral unmixing, a set of images of the tissue section are obtained. The set of images typically includes images corresponding to each one of the IHC and/or IF labels applied to the tissue section, an image corresponding to a counterstain applied to the tissue section (if a counterstain was used), and an image corresponding to tissue autofluorescence. Some or all of the set of images can be displayed to a system operator via display 116. For example, in some embodiments, the set of images can be displayed as individual panes in a multi-pane display. In certain embodiments, two or more images can be pixel-registered against one another and displayed overlapped on display 116. The overlapped images can be used to highlight certain features of the tissue section such as, for example, regions of the tissue section that include one or the other of the individual stains, and regions that include both of the stains. The display modality can be selected by the operator via input/output sub-system 114, or the display modality can be chosen automatically by processor 112. For example, breast tissue sections that are assessed for the presence of malignant tumors can be labeled with antibodies that bind to estrogen receptor (ER) and progesterone receptor (PR). Spectral images of the breast tissue sections can be spectrally unmixed to obtain images that correspond separately to ER staining and PR staining. A composite image formed by overlapping the separate contributions of ER and PR can reveal (e.g., as a differently-colored region on a display) cells which co-express both ER and PR. Invasive ductal carcinomas, for example, may co-express both of these receptors, and the composite image can therefore assist in diagnosing malignant tissue growth.

When the unmixed spectral images of the tissue section have been obtained, the images are analyzed qualitatively and/or quantitatively to guide assessment of the tissue section. Automated or semi-automated image analysis algorithms are applied to the spectral images to determine quantitative signal levels corresponding to different species in the images. In some embodiments, the image analysis algorithms used are trained neural network-based classifiers. Suitable algorithms are disclosed, for example, in U.S. patent application Ser. No. 11/342,272 entitled “CLASSIFYING IMAGE FEATURES” by Richard Levenson et al., filed on Jan. 27, 2006, now published as U.S. Publication No. US 2006/0245631, the entire contents of which are incorporated herein by reference.

The analysis algorithms can be used to locate various classes of cells or sub-cellular constituents (e.g., nucleus, cytoplasm, cell membrane) in the spectral images. Results can be displayed on a display screen (e.g., display 116) to enable a surgeon or other operator to verify that algorithms for finding appropriate cell types/constituents are working, and that erroneous results are correctly rejected.

The individual spectral images can be pixel-registered against one another so that molecular signals from compartments in individual cells can be associated with one another. Multiplexed data can therefore be obtained from individual cells in a manner similar to flow cytometry, but with retention of the tissue section's architectural context.

Neural network-based analysis algorithms are typically trained prior to performing automated analysis of spectral images. In some embodiments, training can be performed with operator guidance using, for example, a spectral image corresponding substantially only to an applied counterstain (e.g., hematoxylin) or an applied nuclear label (e.g., DAPI) to provide a training set for the neural network. Training based on spectral images that correspond to counterstains, for example, enables classification of image features on the basis of morphology rather than molecular phenotype, which can be important to avoid molecular bias. In certain embodiments, vectors determined from a training session can be stored and later re-used, so that the analysis algorithm does not have to be trained each time a new tissue section is analyzed.

The neural network-based algorithms can be trained to recognize various cell classes and tissue classes of interest in images of stained tissue sections. For example, neural network-based algorithms can be trained to automatically identify normal and cancerous regions in a tissue section image, so that operator-based selection of regions-of-interest in images is not required.

For example, in some embodiments, the neural network-based classifier can be trained to differentiate between four different types of regions in breast tissue sections: cancerous, normal, stroma, and inflammation. Training can be extended over multiple examples, but typically, different training samples and algorithms are used for different tissue types and/or cancers.

The neural network-based algorithms are resilient even at low resolution, and can operate on images captured at 4× magnification, ensuring that the classification process is rapid. Typically, for example, classification results are available in as little as 3 minutes or less (e.g., 2 minutes or less, 90 seconds or less, 60 seconds or less, 30 seconds or less).

Following application of the neural network-based classifier to the spectral images of a tissue section, regions of interest that correspond to disease states have been identified against a background of other tissue regions. These regions can correspond, for example, to clusters of cells of interest such as cancer cells. Once the cells of interest are delineated from normal cells and intercellular tissues, individual cells can be identified using methods that include finding cell nuclei (e.g., nuclear segmentation). Unfortunately, cell sectioning processes typically cut through cells at varying heights relative to the nucleus, yielding a broad range of nuclear cross-sections. Further, certain cell types such as cancer cells can be highly variable in shape, and overlapping nuclei and/or tightly packed cell clumps can make separation into individual members very difficult.

The nuclear segmentation approach that is used in the methods and systems disclosed herein is based upon the assumptions that: (a) it will be very difficult to develop a segmentation algorithm that can accurately segment all nuclei in a tissue section; and (b) better statistical information can be obtained from a subset of nuclei that are accurately segmented versus a larger number of nuclei, some of which are poorly segmented. The segmentation algorithm is a multi-stage procedure. In a first stage, the counterstain spectral image of the tissue section is analyzed using the neural network-based classifier to obtain an “as good as possible” segmentation of the nuclei. In a second stage, a subset of well-segmented nuclei are selected from the segmentation in the first stage based on a variety of quality metrics, and statistical and other quantitative data is calculated from the subset of well-segmented nuclei.

In general, once cells of interest have been identified in tissue section images, quantitative data can be extracted from the images. The quantitative data can include, for example: percentages of cells that correspond to particular molecular phenotypes; shape data for individual cells, including dimensions; and other quantitative measures. In some embodiments, this quantitative data can serve as input to algorithms that output diagnoses. For example, diagnostic algorithms can identify different types of cancers and/or other diseases, provide tumor size and rate of growth assessments, and provide guidance to surgeons and/or other medical professionals. Assessment information can be displayed on display 116, for example. In certain embodiments, the assessment information can include a signal to a surgeon (e.g., a red or green indicator) to either move forward with a surgical procedure or to halt the procedure. In general, a variety of different diagnostic and assessment information can be provided to the surgeon via display 116.

Important applications of the methods and systems disclosed herein include intra-operative assessment of tissue sections, and same-day (but not intra-operative) biopsy analysis. Each of these applications requires relatively short turnaround times from excision to assessment. In particular, intra-operative assessment is performed while the patient remains in the operating room, in some cases awaiting further surgical intervention. As a result, the methods and systems disclosed herein achieve rapid turnaround times to enable these applications. In some embodiments, for example, an elapsed time between the beginning of the tissue fixation step and the completion of the assessment step is 60 minutes or less (e.g., 50 minutes or less, 40 minutes or less, 30 minutes or less, 20 minutes or less, 15 minutes or less). These rapid turnaround times enable surgery to proceed on a patient if assessment results determine that further intervention is warranted.

Following assessment of the tissue section images, the stained tissue sections can optionally be directed to storage sub-system 124 via transport system 122 for longer-term storage and possible retrieval in future, as shown in step 214 of flow chart 200. In addition, after rapid sectioning of the fixed tissue sample by the reciprocating cutting tool to generate tissue sections for analysis, the remainder of the fixed tissue can be submitted for standard paraffin embedding and conventional processing to generate archival tissue sections for long-term storage.

The systems and methods disclosed herein provided for a number of significant advantages relative to standard tissue sectioning and analysis protocols. Foremost among these is the relatively rapid rate at which tissue sections can be obtained, processed, and assessed. The rapidity arises from, among other factors, the use of ultrasound-assisted tissue fixation and staining, high-speed reciprocating cutting tool-based tissue sectioning, and obviation of any need for antigen retrieval steps. The systems and methods disclosed herein also provide for preservation of antigens and tissue biochemical environments because processing steps that typically disrupt tissues—including freezing and/or dehydration, paraffin-embedding, and re-hydration—can be eliminated. As a result, images of the tissue sections are typically of high quality and sensitivity, and more accurately reflect in vivo conditions than tissue section images obtained following standard processing protocols.

### Other Embodiments

A number of embodiments have been described. Nevertheless, it will be understood that various modifications may be made without departing from the spirit and scope of the disclosure. Accordingly, other embodiments are within the scope of the following claims.

What is claimed is:

1. A method, comprising:
fixing a tissue sample, obtained from a patient, in a bath of fixing solution by directing ultrasonic waves to be incident on the tissue sample;
sectioning the tissue sample to produce a tissue section, wherein the sectioning comprises removing a portion of the tissue sample with an oscillating blade;
applying one or more stains to the tissue section;
obtaining one or more images of the stained tissue section; and
analyzing the one or more images to provide information useful for assessing a disease state in the patient.

2. The method of claim 1, further comprising assessing a disease state in the patient based on the information.

3. The method of claim 1, wherein the tissue sample is obtained by excising the tissue sample from the patient during an operation.

4. The method of claim 1, wherein the tissue sample is obtained from a sample storage facility.

5. The method of claim 1, wherein the tissue sample is fixed over an elapsed time of 5 minutes or less.

6. The method of claim 1, wherein the fixing solution comprises formaldehyde.

7. The method of claim 1, wherein the fixing solution comprises zinc-based compounds.

8. The method of claim 7, wherein the fixing solution comprises zinc chloride, calcium acetate, and zinc trifluoroacetate.

9. The method of claim 1, wherein prior to sectioning the tissue sample, the sample is enveloped in a solid material.

10. The method of claim 9, wherein the solid material comprises agarose.

11. The method of claim 9, wherein the solid material does not comprise paraffin.

12. The method of claim 9, wherein the sample is not dehydrated prior to enveloping the sample.

13. The method of claim 9, wherein the solid material does not permeate the sample.

14. The method of claim 1, further comprising directing ultrasonic waves to be incident on the tissue sample when the one or more stains are applied.

15. The method of claim 1, wherein the one or more stains comprise materials that include quantum dots.

16. The method of claim 1, wherein the one or more stains comprise a hapten compound.

17. The method of claim 1, wherein analyzing the one or more images comprises spectrally unmixing the one or more images to separate the one or more images into a plurality of component images, each component image corresponding to an individual spectral contribution to the one or more images.

18. The method of claim 17, wherein at least some of the individual spectral contributions correspond to the one or more stains applied to the tissue section.

19. The method of claim 17, wherein at least one of the individual spectral contributions corresponds to tissue autofluorescence.

20. The method of claim 1, wherein analyzing the one or more images further comprises classifying one or more regions of the images.

21. The method of claim 20, wherein classifying one or more regions comprises assigning each of the one or more regions to a particular class based on tissue morphology in each of the one or more regions.

22. The method of claim 20, wherein the classification is based on an image of the tissue section comprising spectral contributions substantially only from a counterstain applied to the tissue section.

23. The method of claim 20, wherein the classification is performed by a neural network-based trained classifier.

24. The method of claim 20, wherein analyzing the one or more images further comprises classifying cells within one or more of the classified regions.

25. The method of claim 24, further comprising identifying at least some of the nuclei of the classified cells.

26. The method of claim 2, wherein assessing a disease state in the patient comprises determining the presence or absence of a disease in the patient.

27. The method of claim 26, wherein the disease is cancer.

28. The method of claim 2, wherein assessing a disease state in the patient comprises determining counts of cells in the tissue section that are stained with at least one of the one or more stains.

29. The method of claim 2, wherein assessing a disease state in the patient comprises determining counts of cells in the tissue section that are stained with more than one of the one or more stains.

30. The method of claim 2, wherein assessing a disease state in the patient comprises providing a signal to a surgeon, wherein the signal indicates to the surgeon to continue a surgical operation or to halt a surgical operation.

31. The method of claim 1, wherein the method is performed during a surgical operation.

32. The method of claim 1, wherein an elapsed time between a beginning of the fixing and an end of the analyzing is three hours or less.

33. The method of claim 32, wherein the elapsed time is two hours or less.

34. The method of claim 33, wherein the elapsed time is one hour or less.

35. The method of claim 34, wherein the elapsed time is 30 minutes or less.

36. The method of claim 1, wherein the ultrasonic waves have a frequency of 1.50 MHz or more.

37. A system, comprising:
a fixing sub-system configured to fix a tissue sample obtained from a patient in a bath of fixing solution;
a sectioning sub-system configured to produce a tissue section from the tissue sample;
a labeling sub-system configured to apply one or more stains to the tissue section;
an imaging sub-system configured to obtain one or more images of the stained tissue section; and
a processor configured to analyze the one or more images and provide information useful for assessing a disease state in the patient.

38. The system of claim 37, wherein the processor is configured to assess a disease state in the patient based on the information.

39. The system of claim 37, wherein the fixing sub-system comprises a transducer configured to generate ultrasonic waves during the fixing.

40. The system of claim 37, wherein the sectioning sub-system comprises a reciprocating cutting tool configured to remove a portion of the sample to produce the tissue section.

41. The system of claim 37, further comprising a display configured to receive images of the tissue section, and to display the images.

42. The system of claim 41, wherein the display is configured to overlay images of the tissue section that correspond to different spectral components to form a composite image.

43. A method, comprising:
fixing a tissue sample obtained from a patient in a bath of fixing solution, sectioning the fixed tissue sample to produce a tissue section, applying one or more stains to the tissue section, obtaining one or more images of the stained tissue section, and analyzing the one or more images to provide information useful for assessing a disease state in the patient,
wherein an elapsed time from a beginning of the fixing to an end of the analyzing is less than 60 minutes.

44. The method of claim 43, further comprising assessing a disease state in the patient based on the information.

45. The method of claim 43, wherein the elapsed time is 30 minutes or less.

46. The method of claim 45, wherein the elapsed time is 20 minutes or less.

47. The method of claim 43, wherein the method is performed during a surgical operation.

48. The method of claim 47, further comprising assessing a disease state in the patient based on the information, wherein the assessing comprises providing a signal to a surgeon to continue the operation or halt the operation.

49. The method of claim 13, wherein the sample is not dehydrated prior to enveloping the sample.

50. The method of claim 49, wherein the solid material does not comprise paraffin.

51. The method of claim 1, wherein the sectioning produces a tissue sample with a thickness of 10 μm or less.

52. The method of claim 49, wherein the sectioning produces a tissue sample with a thickness of 10 μm or less.

53. The system of claim 37, wherein the processor is configured to assess a disease state in the patient based on the information, wherein the fixing sub-system comprises a transducer configured to generate ultrasonic waves during the fixing, and wherein the sectioning sub-system comprises a reciprocating cutting tool configured to remove a portion of the sample to produce the tissue section.

54. The system of claim 53, further comprising a display configured to receive images of the tissue section, and to display the images, and wherein the display is configured to overlay images of the tissue section that correspond to different spectral components to form a composite image.

55. A method, comprising:
fixing a tissue sample, obtained from a patient, in a bath of fixing solution by directing ultrasonic waves to be incident on the tissue sample;
enveloping the tissue section in a solid material that does not permeate the sample;
sectioning the enveloped tissue sample to produce a tissue section;
applying one or more stains to the tissue section; and
obtaining one or more images of the stained tissue section.

56. The method of claim 55, wherein the tissue sample is not dehydrated prior to the enveloping.

57. The method of claim 55, further comprising displaying one or more of the obtained images.

58. The method claim 55, further comprising analyzing the one or more images to provide information useful for assessing a disease state in the patient.
